(19) United States
(12) Patent Application Publication
(10) Pub. No.: US 2022/0108044 A1
(43) Pub. Date: Apr. 7, 2022

(54) Kitchen Renovation System

(71) Applicant: OPR General Contracting, Inc., Oakland, CA (US)

(72) Inventors: Robert John Kalmbach, Piedmont, CA (US); Clayton Miles Corwin, Laguna Beach, CA (US); Mark S. Nowotarski, Stamford, CT (US)

(21) Appl. No.: 17/478,996

(22) Filed: Sep. 20, 2021

Related U.S. Application Data
(60) Provisional application No. 63/086,670, filed on Oct. 2, 2020.

(51) Int. Cl. G06F 30/13; G06K 9/00; G06Q 30/02

(52) U.S. Cl. CPC G06F 30/13; G06Q 30/0283; G06K 9/00624

(57) ABSTRACT

A computer-based kitchen renovation system reads in an address of a residence from a user and an image of a current kitchen to be renovated. The user then selects a design for the renovated kitchen from a limited set of designs. The image of the current kitchen is then analyzed to determine a quantitative kitchen layout. The address, quantitative kitchen layout and the selected kitchen design are then used to determine a cost estimate for the kitchen renovation.

### BACKGROUND

There is need for a system for kitchen renovation that will allow for a kitchen renovation to be initiated and completed, during the process of purchasing and occupying a residence.

### SUMMARY OF INVENTION

The summary of the invention is a guide to understanding the invention. It does not necessarily describe the most generic embodiment.

FIG. 1 is a timeline 100 for a simultaneous residence purchase and kitchen renovation. The steps 101 of purchasing a residence may comprise one or more of:

a) listing a residence for sale by a seller;

b) a visit of the residence by a buyer;

c) an offer by the buyer to purchase the residence;

d) an execution by the buyer and seller of a contract to purchase the residence;

e) an inspection of the residence by an engineer;

f) an application by the buyer for a loan from a lender;

g) an approval by the lender of said loan;

h) a close of escrow where funds are provided by the lender to the seller, and title of the residence is transferred from the seller to the buyer; and

i) occupation of the residence by the buyer if that is the buyer's intention.

The above-referenced steps for residence purchase are for illustration only. Different steps may be executed in different particular situations. For example, if the buyer is an iBuyer, then the iBuyer will normally not occupy the residence. Instead, the iBuyer may resell the residence in a short time frame. There also may not be a loan application step or loan approval step if the buyer, such as an iBuyer, already has the funds to purchase the residence. As used herein, purchasing a residence also includes purchasing shares in a coop such that a residence in the coop can be occupied by a buyer.

The steps for purchasing a residence may typically occur over a 1 to 2-month period. Uncertainty 102 in the timing of each step of the purchasing process may accumulate into a relatively large uncertainty 103 on the actual close of escrow date relative to when the initial visit occurred. This uncertainty includes the possibility that the sale may not be executed at all.

A common desire among buyers is to renovate at least a portion of the residence before occupying it. A common room to renovate is the kitchen. For illustration purposes, the system described herein will be described with respect to kitchen renovation. The same system, however, is applicable to any sort of renovation of a residence, such as a bathroom renovation.

The steps 110 for executing a kitchen renovation may include:
a) the buyer seeing that a kitchen renovation is needed;
b) the buyer selecting a kitchen design;
c) the buyer receiving a quote for renovating the kitchen according to the selected kitchen design;
d) selecting a contractor to perform the kitchen renovation;
e) executing a contract between the buyer and the contractor for the renovation;
f) making an initial payment to the contractor;
g) the buyer receiving funds for the renovation at the close of escrow if the renovation costs are included in the loan application;
h) the contractor renovating the kitchen; and
i) the buyer providing final payment to the contractor.

If the kitchen renovation process is to occur simultaneously with the residence purchase process, then there is a technical challenge of performing the renovation steps in a relatively short period of time 111 with the above-mentioned uncertainty in the closing date so that the renovation can be performed shortly (e.g. 1 to 2 days) after the buyer receives title to the residence.

FIG. 2 is an illustration of a computer-implemented system 200 for kitchen renovation. The system may comprise:
a) a registration module 201 for registering a user 230 (e.g. a buyer);
b) a design module 202 for storing and displaying one or more of a plurality of kitchen designs (e.g. 211, 212) to the user;
c) a pricing module 203 for determining a price for a selected kitchen design renovation;
d) a contracting module 204 for executing a contract between the user 230 and a contractor (e.g. 240, 241) for renovating said kitchen; and
e) a scheduling module 205 for scheduling the kitchen renovation.

The system 200 may also comprise a payment module (not shown) for receiving payment from the user and providing payment to the contractor.

The system may also comprise a human administrator 206 that will perform certain functions of the system manually.

The kitchen renovation system may also comprise:
a) an input device (e.g., one or more of a user input device 231, a database input device 235, a contractor input device 243, or an administrator input device 207);
b) an output device (e.g., one or more of a user output device 232, a database output device 234, an contractor output device 242 or an administrator output device 208);
c) a microprocessor (part of system 200); and
d) a permanent memory (part of system 200) comprising computer readable instructions (part of system 200) operable to cause said microprocessor to physically carry out the steps:
   i) read in 259 from a user 230, via said input device, an address of a residence;
   ii) determine 260 that said residence meets a set of criteria comprising one or more of:
      1) said residence was built in a given time frame; or
      2) said residence is one of a plurality of residences of a same design; and
   iii) upon said determination that said residence meets said set of criteria, execute the steps:
      1) present to said user, by said output device, a plurality 202 of kitchen designs (e.g. 211, 212); and
      2) receive from said user by said input device:
         a) a selection 262 of one of said plurality of kitchen designs; and
         b) at least one of 263:
         i) an image 250 showing a view of a current kitchen of said residence; or
         ii) a measurement-based layout 251 of said current kitchen showing locations and dimensions 264 of at least one or more of:
         1) one or more cabinets;
         2) one or more appliances;
         3) a floor; or
         4) one or more walls;
      3) determine 267 an estimated price for renovation of said current kitchen based on:
         a) said selected kitchen design; and
         b) at least one of said image of said current kitchen or said measurement-based layout of said current kitchen;
      4) present to said user, by said output device, said estimated price of said renovation;
      5) receive from said user, by said input device:
         a) an acceptance of said estimate;
         b) a monetary deposit; and
         c) a start date for said renovation; and
      6) upon receipt of said acceptance of said estimate, execute the steps:
         a) offer to a contractor 241, by said output device, a proposal to perform said renovation for said estimated price, said renovation starting on said start date;
         b) receive 268 from said contractor, by said input device, an acceptance of said proposal;
         c) bind 269 said user to said contractor with a contract for said renovation; and
         d) schedule 270 said start date for said renovation

wherein:
e) said given time frame for said construction of said residence is between 0 and 50 years prior to a present date; and
f) a number of said plurality of residences of said same design is 20 or more.

As used herein, a kitchen design may comprise a specification of one or more of:
a) an upper cabinet style, hardware, pattern, and color palette 221;
b) a lower cabinet style, hardware, pattern, and color palette 222;
c) a countertop style, pattern, and color palette 223;
d) a backsplash style, pattern, and color palette 224;
e) a floor style, pattern, and color palette 225; or
f) a paint color 226.

The plurality of kitchen designs 202 that are presented to said user may comprise between 3 and 20 different designs. This is a small number of designs compared to the range of designs offered by a typical kitchen designer. The purpose of the small number of designs is to help the user select a desired design quickly so that the relatively tight time frame 111 (FIG. 1) for the kitchen renovation process can be competed simultaneously with the residence purchasing process 101 (FIG. 1).

The plurality of kitchen designs presented to a user may be a function of where the residence is located. The plurality of designs may reflect design preferences in a given region (e.g. Los Angeles, Calif.; Las Vegas, Nev.; Santa Fe, N. Mex.). Thus, the system 200 may comprise a plurality of sets of designs with each set of designs comprising 3 to 20 kitchen designs. Any number of sets of designs may be present in the system. Sets of designs may also be constructed based on demographic factors of the buyer, such as age, family status, etc. Demographic status may be input by the user to the system or may be inferred from external databases (e.g. social media postings such as lnstagram photos) or cookies previously stored on a user's input/output device (e.g. phone).

Designs may be updated and retired over time as regional tastes change. Designs may be update yearly, for example.

An advantage of limiting the time frame of construction of the residence to be between 0 and 50 years prior to the present date is that the probability of a significant modification of the floor plan of the residence (e.g. a kitchen expansion) may be small. This will facilitate determining the layout of a kitchen since original construction plans can be used. Even if there have been modifications, municipal building permit records can be queried to determine a current layout of a kitchen.

An advantage of limiting the number of residences with the same design to 20 or more is that this will limit offerings to residences that were mass produced and hence more likely to have a standard kitchen design. This will facilitate determining the layout of a kitchen and stocking standard sized design items (e.g. cabinets) for installation in the renovation. This will reduce the effort and increase the accuracy of the estimate of the kitchen renovation cost.

For large enough housing developments (e.g. 100 units or more), it may be worthwhile to precompute estimated kitchen renovation costs. User input 263, therefore, can be used primarily to validate the precomputed estimates. If the user input shows a significant discrepancy from the standard kitchen design in a given housing development, then manual input from the administrator 206 (e.g. an onsite visit) may be used to modify the cost estimate.

Residences may also be limited to those with an asking price in a given range. For example, in the United States, if a residence has an asking price in a range that qualifies the buyer for an FHA (Federal Housing Authority) mortgage, then the mortgage can be easily resold. This increases the odds for a mortgage to be approved and thus reduces the probability that the sale of the residence will not occur after the process 111 (FIG. 1) for kitchen renovation is commenced. The range of asking price can also be selected such that qualifying residences are more likely to be in a housing development were a large number of residences were built with the same kitchen design. This will facilitate calculating the estimated price of the renovation.

A kitchen design may be presented to a user by any presentation means, such as one or more of:
a) perspective color rendering 220;
b) a three-dimensional rendering where a user may manipulate a perspective of a kitchen design presented on an output device 232 by providing input on an input device 231 (e.g. mouse movement or finger movement on a touchscreen to see different views of the kitchen design); or
c) an augmented reality rendering where a user points an input device 231 to a portion of a current kitchen and the system overlays a kitchen design on the view of the current kitchen presented on an output device 232 (e.g. a user's phone). Thus, when a user is in a current kitchen to be renovated and, for example, holds up their phone with the camera on, what they see is what the kitchen will look like after renovation.

A rendering of a kitchen design may also include one or more accent pieces 228 (e.g. a plant) or exemplary appliances 227 (e.g. a dishwasher). The accent pieces and exemplary appliances may or may not be part of the offered kitchen design.

A mood board 229 may also be presented in conjunction with the kitchen design. The mood board may comprise portions of the elements of the kitchen design (e.g. cabinet door, floor sample, backsplash sample, etc.) as well as accent pieces (e.g. fruit, fabric swatches for curtains, utensils, etc.) to help a user visualize the mood of the kitchen design.

The system 200 may be adapted to determine an image-base layout of the current kitchen, based on quantitative analysis 265 of the image of the current kitchen uploaded by the user. This will be discussed in more detail below.

The system 200 may be adapted to query one or more external databases 233. The registration module 201, for example, may query a satellite image database 236 (e.g. Google Maps) to verify that the residence address provided by the user exists 261 and that the residence outline has not changed relative to the residence's original design.

The system 200 may query 266 an external database 233 to download one or more of:
a) an image 237 of said current kitchen archived in a database wherein the database may be a database of prior sale listing of said residence (e.g. Zillow, Redfin, or other real estate listing database); or
b) a measurement-based layout 238 archived in a database (e.g. municipal records) of original construction plans for said residence or construction permit records for changes made to a residence after original construction.

In order to be current, the age of the images read in from an archive database may be limited to a certain maximum value, such as one year. If said recent archived images are available, then it may not be necessary to receive any images or floor plans from a user. This will substantially reduce the time and effort required of a user to get an accurate cost estimate for renovation. Alternatively, archived images even as old as 20 years may be suitable given that many people maintain their kitchen design for extended periods of time. When multiple archived images are available, then preference may be given to the most recent image. Images may also be available as one or more frames from a video recording or one or more views from a three-dimensional image of a kitchen.

### BRIEF DESCRIPTION OF DRAWINGS:

FIG. 1 is a timeline for simultaneous residence purchase and kitchen renovation.

FIG. 2 is a computer-implemented system for kitchen renovation.

FIG. 3 is a kitchen renovation method flowchart.

FIG. 4 is a rendering of a set of kitchens.

FIG. 5 is an illustration of an image analysis method for an elevational perspective view of a kitchen wall.

FIG. 6 is an illustration of an image analysis method for an oblique perspective view of a kitchen wall.

FIG. 7 is an illustration of an image analysis method for a panoramic view of a kitchen wall.

### DETAILED DESCRIPTION:

The detailed description describes non-limiting exemplary embodiments. Any individual features may be combined with other features as required by different applications for at least the benefits described herein. As used herein, the term “about” means plus or minus 10% of a given value unless specifically indicated otherwise.

As used herein, a “computer-implemented system” or “system” comprises an input device for receiving data, an output device for outputting data in tangible form (e.g. printing or displaying on a computer screen), a permanent memory for storing data as well as computer code, and a microprocessor for executing computer code wherein said computer code resident in said permanent memory will physically cause said microprocessor to read-in data via said input device, process said data within said microprocessor and output said processed data via said output device.

As used herein, a “module” of a computer-based system comprises computer code that when executed on said microprocessor will cause said microprocessor to carry out a given function. For example, a “pricing module”, comprises a set of computer instructions that will cause said microprocessor to carry out the steps to determine a price.

As used herein, disclosure of a computer-based system or an element thereof is also a disclosure of a plurality of said computer-based systems and elements thereof. A computer-based system, for example, may include a cloud-based computer system which may comprise a plurality of microprocessors and/or virtual microprocessors each executing at least a portion of said computer code remotely from each other but in digital communication with each other. Similarly, an input device, such as a phone or a plurality of phones, may comprise a plurality of input devices and output devices, such as one or more cameras, microphones, touch screens, speakers, etc., each on different devices.

As used herein, the term “shaped” means that an item has the overall appearance of a given shape even if there are minor variations from the pure form of said given shape.

As used herein, the term “generally” when referring to a shape means that an ordinary observer will perceive that an object has said shape even if there are minor variations from said shape.

As used herein, relative orientation terms, such as “up”, “down”, “top”, “bottom”, “left”, “right”, “vertical”, “horizontal”, “distal” and “proximal” are defined with respect to an initial presentation of an object and will continue to refer to the same portion of an object even if the object is subsequently presented with an alternative orientation, unless otherwise noted.

As used herein, “left”, “right”, “front”, and “back” are from the perspective of an object, unless indicated otherwise.

### Process Flowchart

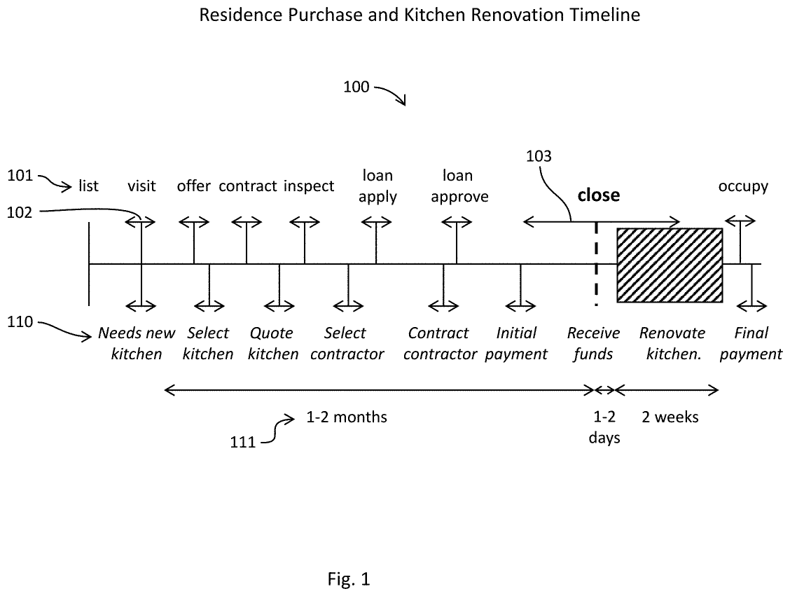

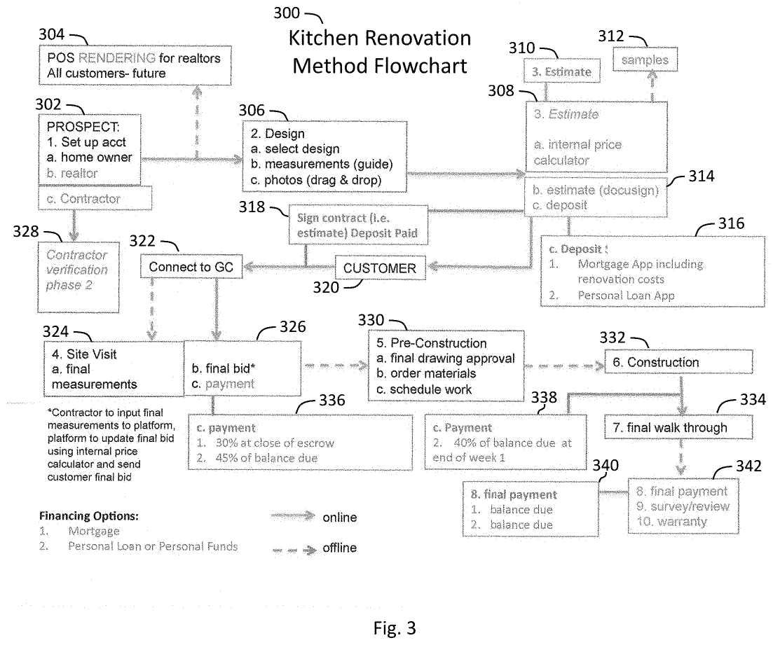

FIG. 3 is a kitchen renovation method flowchart 300. The method steps executed by the system 200 may include one or more of the following.
An initial step 302 where one or more of a homeowner, realtor or contractor sets up an account within the system. A realtor may set up an account in order to show prospective buyers the different kitchen renovation options. One or more contractors (e.g. 240, 241 FIG. 2) may set up an account in order to be verified 328 as a suitable contractor for performing kitchen renovations in a given region. With proper qualification, a user will be indifferent to the particular contractor chosen 268 (FIG. 2) to perform the renovation. Thus, the system may select verified contractors based on proximity to a residence to be renovated and availability to perform a renovation in a desired time frame (111 FIG. 1).
Data from the initial step may be archived 304 for future use. The archived data may include point-of-sale (POS) rendering of the current kitchen for realtors. The archived data may also include an augmented reality (AR) rendering of the current kitchen with one of the set of kitchen designs 202 (FIG. 2) overlaid on the image of the current kitchen.
Once a user is registered, the user may select 306 a design and provide measurements or photos of the current kitchen as described above.
The system will then calculate 308 an estimate of the renovation, and optionally provide 312 physical samples of cabinets, etc. to the user. Physical samples may be provided by the administrator 206 (FIG. 2). Estimates may be precalculated and stored 310 for future use.
The estimate may then be provided 314 to the user. The user may then accept the estimate through an automated contracts process (e.g.)DocuSign®. The user may then provide a deposit. A suitable deposit may be in the range of 5 to 10 percent of the estimate.
At this point, the user may seek to finance 316 the renovation either through their mortgage application (FIG. 1) or through a personal loan.
The user (e.g. customer 320) may then sign a contract 318 for the renovation.

The contract may stipulate that a verified contractor will perform the renovation but will not necessarily name the specific contractor. This is similar in concept to when a user contracts through an app for a car service (e.g. Uber) with the service specifying that a verified driver will perform the driving.
The system will then select 322 the contractor (e.g. GC) to perform the renovation. As indicated above, this may be based on proximity of the contractor to the residence to be renovated as well as the contractor's availability to perform the renovation in the desired time frame.
The contractor may then visit 324 the residence to be renovated to make final measurements.
The contractor may then submit 326 a final bid for the renovation. An advantage of the system 200 is that it is able to make initial estimates for the renovation that are within 10% of the contractor's final bid. Thus, a user can commit to the renovation before the final bid is determined. This helps allow the system to meet the tight time frame of a simultaneous residence purchase and renovation.
After close of escrow, the contractor then renovates the kitchen. This includes receiving 336 an initial payment, preparation 330, construction 332, receiving an intermediate payment 338, a final walkthrough 334 by the user, receiving final payment 340, and provision of a warranty 342 and survey/review by the user.

### Set of Kitchens

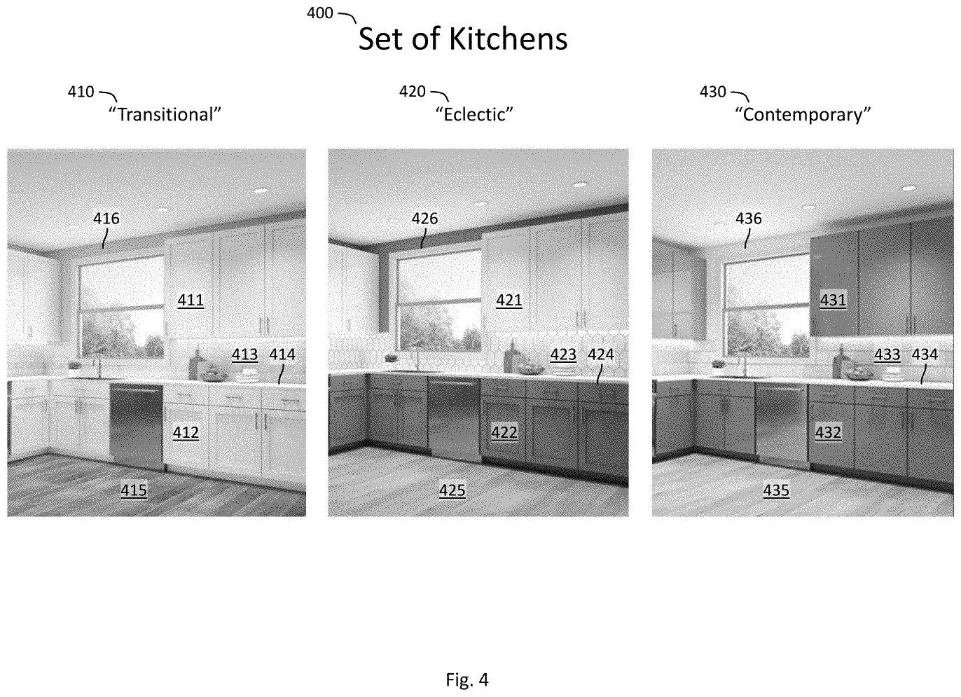

FIG. 4 is a rendering of an exemplary set 400 of kitchens. The set has three designs: “Transitional” 410; “Eclectic” 420; and “Contemporary” 430. The upper cabinets 411, 421, 431; lower cabinets 412, 422, 432; backsplashes 413, 423, 433; counter tops 414, 424, 434; flooring 415, 425, 435; and wall paint 416, 426, 436; for each design can be seen.

The kitchen color palettes are based on neutral colors (e.g. white, grey, and/or shades of tan) such that they will likely be acceptable to most users.

The cabinets are based on common styles, such as “shaker” or “contemporary”. This allows the cabinets to be sourced from high volume cabinet manufacturers such that an existing stock will be available from local suppliers when a renovation commences. This reduces the delivery time from 4-10 weeks or more for custom cabinets to 1 or 2 days. The fast delivery helps the system meet the tight time frame for the renovation in light of uncertainly in the start date of actual physical construction.

### Image Analysis

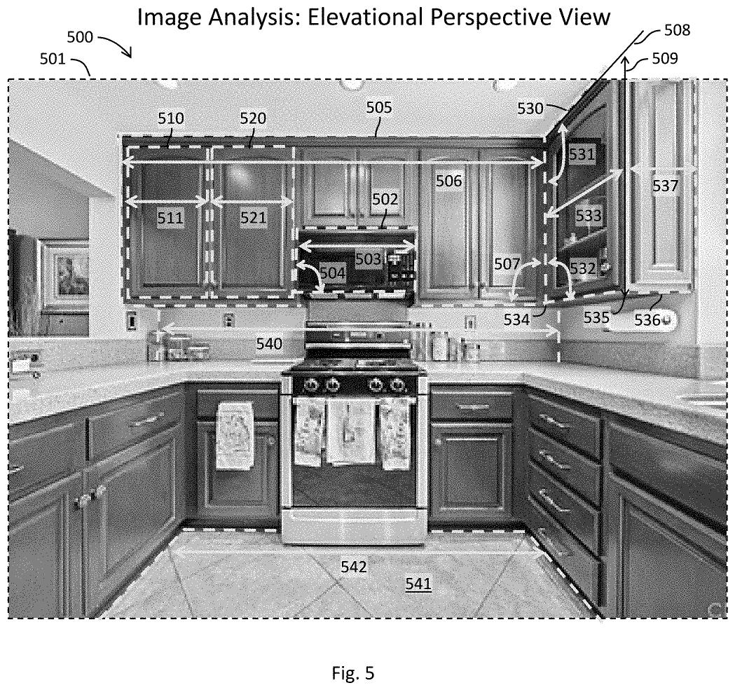

FIG. 5 is an illustration of an image analysis method 500 suitable for an elevational perspective view 501 of a kitchen wall. The image analysis method will determine a quantitative image-based layout of a current kitchen. The image-based layout will provide measurements and locations of various objects of the kitchen, such as cabinets and floors. The quantitative measurements may be used by the pricing module 203 (FIG. 2) to determine an estimated price for a kitchen renovation.

A method for determining an image-based layout may comprise the steps:
a) identify, within an image 501, a reference appliance 502 of known real dimensions;
b) calibrate image dimensions to real dimensions over a field of said image, said calibration being based on image dimensions 503 of said reference appliance and said known real dimensions of said reference appliance;
c) identify, within said image, a cabinet face (e.g. 510, 520);
d) determine image dimensions (e.g. 511, 521) of said cabinet face in said image; and
e) determine real dimensions of said cabinet face based at least in part on said image dimensions of said cabinet face and said calibrated image dimensions.

As used herein, “real dimensions” refers to actual dimensions of an object. A standard real width of a microwave oven in the United States, for example, is about 30 inches.

As used herein, “image dimensions” refers to dimensions within an image. In FIG. 5, for example, the image width of the microwave oven 502 is about 1.12 inches. Image dimensions may also be a pixel count for digital images.

As used herein, “calibrated image dimensions” refers to a conversion of image dimensions to real dimensions. As will be discussed in more detail below, calibrated image dimensions can vary over an image depending upon the orientation of a surface of an object in said image. Regarding the face of the microwave oven 502, the image calibration for both height and width is 30/1.12 or 26.78 real inches/image inches.

As used herein, double-headed arrows in an image may collectively refer to all dimensions of an object (e.g. height, width, angles between adjacent edges, etc.) or may refer to a particular dimension (e.g. width) depending upon the context. Curved double-headed arrows that connect adjacent edges of an object may refer to the angle between said adjacent edges or collectively all angles between adjacent edges or an object, depending upon the context. Angles may be real angles or image angles depending upon the context.

As used herein, a “reference appliance” is any object in an image where the real dimensions are known a priori. For example, in the United States, a microwave oven installed over a range has a standard width of about 30 inches and a standard height of about 16 inches. The standard real angles 504 between adjacent edges is 90 degrees. Dishwashers, ranges and standard-size cabinets are also reference appliances. Wall widths (e.g. 540) may be reference appliances if the wall widths for a particular kitchen are known beforehand. Wall widths, for example, may be available from construction records or renovation records for a particular kitchen. They may also be measured beforehand.

As used herein, a “face” of an object, or a “plane” is a generally planar surface. This accepts the fact that surfaces may have small variations from a plane, such as a curvature, molding or offsets.

The step of determining an image-based layout for an elevational perspective view of a kitchen wall may comprise the steps:
a) identify a reference plane 505 of object faces in said image that are in about a same plane as a face of a reference appliance 502, said reference plane being defined by one or more of a top horizontal edge, bottom horizontal edge, left vertical edge and right vertical edge; and
b) determine calibrated image dimensions within said reference plane based at least in part on:
   i) one or more image lengths 506 of said edges of said reference plane; and
   ii) one or more image angles 507 between adjacent edges of said reference plane.

In FIG. 5, image lengths 506 of opposite edges of the reference plane are about the same. Image angles 507 of adjacent edges of the reference plane are all about 90 degrees. The face of the reference appliance 502 is in about the same plane (e.g. within +/−2 inches) as the reference plane. The calibrated imaged dimension throughout the reference plane therefore, is about 26.78 real inches/image inches for both vertical and horizontal dimensions.

The image width of the reference plane is 4.02 inches. The real width of the reference plane, therefore, is about 4.02*26.78 or 107.6 inches or 8.97 feet. This is close to a standard width for a set of cabinets of 9 feet.

There may be one or more oblique planes (e.g. 530) visible in an elevational perspective view of a kitchen. An oblique plane may be identified by a top real horizontal edge, bottom real horizontal edge, left real vertical edge and right real vertical edge. An oblique plane may be identifiable in an image based on image angles (e.g. 531, 532) between adjacent edges that are different than 90 degrees. They may also be identified by top and bottom image edges that diverge. It is known a priori that standard kitchen walls are orthogonal to each other. Hence the oblique plane is orthogonal to the reference plane.

If an oblique plane intersects a reference plane, it is termed herein an “extension” plane. Dimensions on a projection plane that are orthogonal to a reference plane can be determined if a reference appliance is shown in an image with a known orthogonal dimension. If a cabinet face in the extension plane is a standard size, for example, then the real width of the cabinet face can be used to determine image calibrations throughout the extension plane. The vertical and horizontal calibrations may differ from each other and may vary over the image of the extension plane.

Image calibration can be done using the methods of single-point perspective. This can be done even if a reference appliance is not visible in an extension plane if a real distance from the device that recorded the image to the reference plane is known. The distance can be downloaded from the metadata of an image taken by the device.

The step of determining an image-based layout may further comprise the steps:
a) identify an extension plane of one or more object faces in an image that intersects a reference plane, said extension plane being defined by one or more of a top horizontal edge, bottom horizontal edge, left vertical edge and right vertical edge; and
b) determine calibrated image dimensions within said extension plane based at least in part on:
   i) one or more image lengths 533 of said edges of said extension plane;
   ii) one or more image angles 531, 532 between adjacent edges of said extension plane; and
   iii) image dimensions of a reference appliance in said extension plane or a known distance from a device that recorded said image and said reference plane in said image.

The top edge and left edge of the extension plane in this example is partially cropped. The edges, however, can be extended 508, 509, so that the image length of the left edge can be measured directly from the image. In this example, the right edge 534 has an image length of 1.62 inches. The left edge 535 has an image length of 2.3 inches. The calibrated vertical image dimensions along the left edge, therefore, are 26.78*(1.62/2.3) or about 18.86 real inches/image inches. Calibrated vertical image dimensions at intermediate positions within the extension plane can be similarly determined by scaling according to the vertical image distance from the top edge of the extension plane to the bottom edge of the extension plane.

A cabinet face 536 orthogonal to the extension plane is visible in the image. This cabinet face defines a projection plane that intersects the extension plane. The projection plane is parallel to the reference plane. Image calibrations within the projection plane can be calculated using:
i) one or more vertical image lengths of said left and right edges of said projection plane; and
ii) the calibrated image dimensions within said reference plane.

In this example, the opposite edges of the projection plane are parallel in the image and the adjacent edges are orthogonal in the image. Hence, similar to the reference plane, the vertical and horizontal image calibration have the same value within the projection plane. The vertical image calibration of the extension plane at the left edge of the extension plane is about 18.86 real inches/image inches. Hence the image calibration in the projection plane is also about 18.86 real inches/image inches.

The image width of the cabinet face in the projection plane 536 is about 0.66 inches. The real width of the cabinet face, therefore is determined to be 0.66*18.86 or 12.44 inches. This is close to the standard depth of upper kitchen cabinets of about 12 inches.

Knowing standard dimensions of objects in a kitchen allows calculated dimensions to be corrected or flagged for verification. If a small discrepancy is found, then calculated dimensions can be rounded off to the nearest standard dimension. This can be helpful when multiple rounds of extension and projection planes are used to determine image calibrations in various portions of an image. The multiple rounds of extension and projection plane calculations can lead to accumulated errors. Rounding off to the nearest standard dimension in intermediate steps of a calculation helps reduce the accumulation of these errors.

Multiple rounds of extension and projection planes may be helpful in determining dimensions of objects far from the calibration plane. These objects might include, for example, the dimensions 542 of a floor 541.

If there is a significant discrepancy between calculated real dimensions and standard dimensions, then that may indicate that an on-site visit is necessary to validate that the dimensions are indeed non-standard.

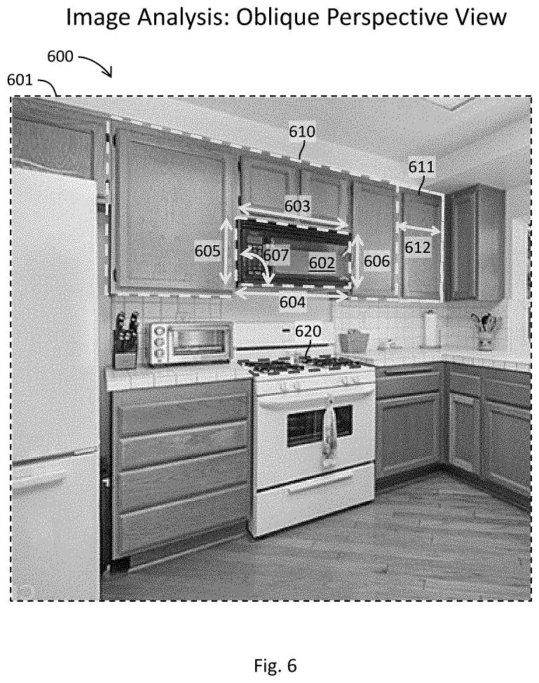

FIG. 6 is an illustration of an image analysis method 600 for an oblique perspective view 601 of a kitchen wall. A reference appliance 602 (microwave oven) is identified in the image.

Identification of a reference appliance can be automated using neural network technology. A digital representation of an image is input into a neural network trained to identify reference appliances. The neural network then identifies the reference appliance.

The neural network can be trained on a training set of kitchen images taken from various perspectives wherein the reference appliances have been previously identified. The neural net can also be trained to recognize edges of objects, such as cabinet edges, using similar training sets.

When a plane of a face of a reference appliance is in oblique view, the image calibrations within the reference plane 610 can be determined. The different image lengths of the edges 603, 604, 605, 606 of the face of the reference appliance along with the adjacent edge angles 607 can be used to determine the image calibrations in the vicinity of said edges. The image calibrations throughout the reference plane can then be determined from the various edge lengths and the calibrations in the vicinities of the edges of the reference appliance. For example, using the vertical image height 606 of the reference appliance, its known real height of 16 inches, and the convergence of the upper and lower edges of the reference plane, one can calculate a real width 612 of the far-left cabinet face 611 of about 14.5 inches. This is close to a standard width for a cabinet of 15 inches.

Similar calculations can be done for horizontal planes, such as the plane 620 of the top of a range. The range is a reference appliance with standard height, width and depth.

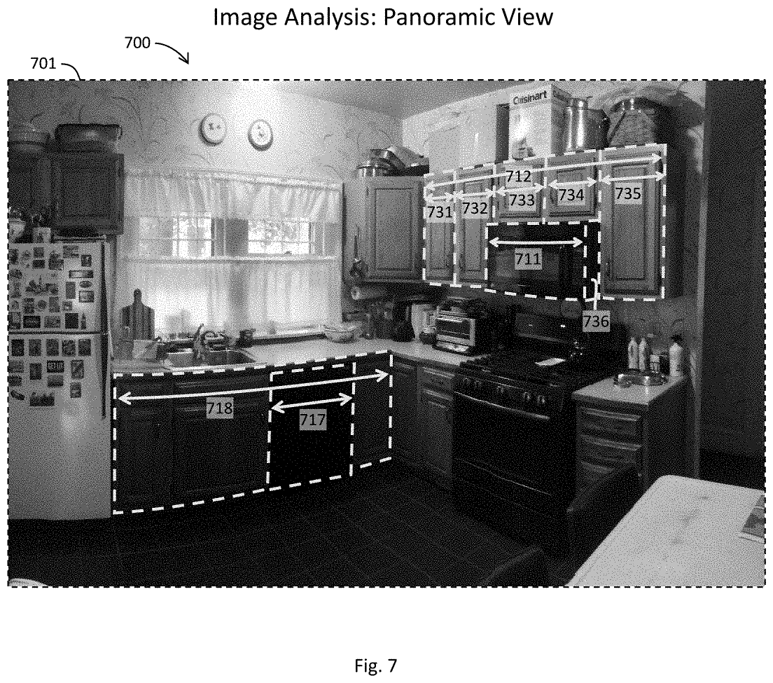

FIG. 7 is an illustration of an image analysis method 700 for a panoramic view 701 of more than one kitchen wall. A characteristic of panoramic views is that the image edges of a plane will be curved, particularly horizontal edges. Determining an image-based layout from a panoramic image may comprise the steps:
i) identify a reference plane 712 of one or more object faces in the panoramic image that are in about a same plane as a face 711 of a reference appliance, said reference plane being defined by one or more of a top horizontal edge, bottom horizontal edge, left vertical edge and right vertical edge;
ii) identify within said reference plane, one or more subplanes (e.g. 731, 732, 733, 734, 735) of said object faces, each subplane being defined by one or more of a top horizontal edge, bottom horizontal edge, left vertical edge and right vertical edge;
iii) identify a first one of said subplanes (e.g. 732) adjacent to said reference appliance;
iv) determine said calibrated image dimensions within said first subplane plane based at least in part on:
   1) one or more image lengths of said edges of said first subplane; and
   2) said calibrated image dimensions within said plane of said face of said reference appliance adjacent to said first subplane;
v) identify a second one of said subplanes (e.g. 731) adjacent to said first subplane; and
vi) determine said calibrated image dimensions within said second subplane plane based at least in part on:
   1) one or more image lengths of said edges of said second subplane; and
   2) said calibrated image dimensions within said first subplane adjacent to said second subplane.

Breaking the reference plane up onto subplanes allows the methods described above to be used to determine image calibrations in each of the subplanes even when the image edges of a reference plane are curved.

If the plane of the face of the reference appliance is significantly offset 736 from the reference plane, then the image calibrations in the reference plane can be determined using the extension and projection plane methods described above.

An advantage of a panoramic view is that multiple walls as well as multiple reference appliances can be seen in the same image. A dishwasher face 717 can be seen in the panoramic image 701. Dishwashers in the United States have standard dimensions. Hence, they are considered reference appliances. The dishwasher face can be used to determine image calibrations in a reference plan 718 associated with the dishwasher face.

### CONCLUSION

While the disclosure has been described with reference to one or more different exemplary embodiments, it will be understood by those skilled in the art that various changes may be made and equivalents may be substituted for elements thereof without departing from the scope of the disclosure. In addition, many modifications may be made to adapt to a particular situation without departing from the essential scope or teachings thereof. Therefore, it is intended that the disclosure not be limited to the particular embodiment disclosed as the best mode contemplated for carrying out this invention.

We claim:

1. A kitchen renovation system comprising:
a) an input device;
b) an output device;
c) a microprocessor; and
d) a permanent memory comprising computer readable instructions operable to cause said microprocessor to physically carry out the steps:
i) read in from a user, via said input device, an address of a residence;
ii) determine that said residence meets a set of criteria comprising one or more of:
1) said residence was built in a given time frame; or
2) said residence is one of a plurality of residences of a same design; and
iii) upon said determination that said residence meets said set of criteria, execute the steps:
1) present to said user, by said output device, a plurality of kitchen designs; and
2) receive from said user by said input device:
a) a selection of one of said plurality of kitchen designs; and
b) at least one of:
i) an image showing a view of a current kitchen of said residence; or
ii) a measurement-based layout of said current kitchen showing locations and dimensions of at least one or more of:
1) one or more cabinets;
2) one or more appliances;
3) a floor; or
4) one or more walls;
3) determine an estimated price for renovation of said current kitchen based on:
a) said selected kitchen design; and
b) at least one of said image of said current kitchen or said measurement-based layout of said current kitchen;
4) present to said user, by said output device, said estimated price of said renovation;
5) receive from said user, by said input device:
a) an acceptance of said estimate;
b) a monetary deposit; and
c) a start date for said renovation; and
6) upon receipt of said acceptance of said estimate, execute the steps:
a) offer to a contractor, by said output device, a proposal to perform said renovation for said estimated price, said renovation starting on said start date;
b) receive from said contractor, by said input device, an acceptance of said proposal;
c) bind said user to said contractor with a contract for said renovation; and
d) schedule said start date for said renovation
wherein:
e) said given time frame for said construction of said residence is between 0 and 50 years prior to a present date; and
f) a number of said plurality of residences of said same design is 20 or more.

2. The kitchen renovation system of claim 1 wherein said step of determining said estimated price for said renovation of said current kitchen comprises the steps:
a) determine an image-based layout of said current kitchen based on said image of said current kitchen; and
b) determine said estimate of said renovation of said current kitchen using at least in part said image-based layout.

3. The kitchen renovation system of claim 2 wherein said step of determining an image-based layout comprises the steps:
a) identify, within said image, a reference appliance of known real dimensions;
b) calibrate image dimensions to real dimensions over a field of said image, said calibration being based on image dimensions of said reference appliance and said known real dimensions of said reference appliance;
c) identify, within said image, a cabinet face;
d) determine image dimensions of said cabinet face in said image; and
e) determine real dimensions of said cabinet face based at least in part on a said image dimensions of said cabinet face and said calibrated image dimensions.

4. The kitchen renovation system of claim 3 wherein said reference appliance is one or more of a microwave oven, a range, a cabinet, or a dishwasher.

5. The kitchen renovation system of claim 3 wherein said view of said current kitchen in said image comprises one or more of:
a) an elevational perspective view of a wall of said current kitchen;
b) an oblique perspective view of a wall of said current kitchen; or
c) a panoramic view of a wall of said current kitchen.

6. The kitchen renovation system of claim 5 wherein said step of determining said image-based layout further comprises the steps:
a) identify a reference plane of object faces in said image that are in about a same plane as a face of said reference appliance, said reference plane being defined by one or more of a top horizontal edge, bottom horizontal edge, left vertical edge and right vertical edge; and
b) determine said calibrated image dimensions within said reference plane based at least in part on:
i) one or more image lengths of said edges of said reference plane; and
ii) one or more image angles between adjacent edges of said reference plane.

7. The kitchen renovation system of claim 6 wherein said step of determining an image-based layout further comprises the steps:
a) identify an extension plane of one or more object faces in said image that intersects said reference plane, said extension plane being defined by one or more of a top horizontal edge, bottom horizontal edge, left vertical edge and right vertical edge; and
b) determine said calibrated image dimensions within said extension plane based at least in part on:
i) one or more image lengths of said edges of said extension plane;
ii) one or more image angles between adjacent edges of said extension plane; and
iii) image dimensions of a reference appliance in said extension plane or a real distance from a device that recorded said image to said reference plane
wherein said extension plane is orthogonal to said reference plane.

8. The kitchen renovation system of claim 7 wherein said step of determining an image-based layout further comprises the steps:
a) identify a projection plane of object faces in said image that intersects said extension plane, said projection plane being defined by one or more of a top horizontal edge, bottom horizontal edge, left vertical edge and right vertical edge; and
b) determine said calibrated image dimensions within said projection plane based at least in part on:
i) one or more vertical image lengths of said left and right edges of said projection plane; and
ii) said calibrated image dimensions within said reference plane wherein said projection plane is parallel to said reference plane.

9. The kitchen renovation system of claim 5 wherein:
a) said view is a panoramic view; and
b) said step of determining an image-based layout further comprises the steps:
i) identify a reference plane of one or more object faces in said image that are in about a same plane as a face of said reference appliance, said reference plane being defined by one or more of a top horizontal edge, bottom horizontal edge, left vertical edge and right vertical edge;
ii) identify within said reference plane, one or more subplanes of objects, each subplane being defined by one or more of a top horizontal edge, bottom horizontal edge, left vertical edge and right vertical edge;
iii) identify a first one of said subplanes adjacent to said reference appliance;
iv) determine said calibrated image dimensions within said first subplane plane based at least in part on:
1) one or more image lengths of said edges of said first subplane; and
2) said calibrated image dimensions within said plane of said face of said reference appliance adjacent to said first subplane;
v) identify a second one of said subplanes adjacent to said first subplane; and
vi) determine said calibrated image dimensions within said second subplane plane based at least in part on:
1) one or more image lengths of said edges of said second subplane; and
2) said calibrated image dimensions within said first subplane adjacent to said second subplane.

10. The kitchen renovation system of claim 3 wherein said step of identifying within said image a reference appliance comprises the step of inputting a digital representation of said image into a neural network trained to identify reference appliances.

11. The kitchen renovation system of claim 3 wherein said step of determining said real dimensions of said cabinet face comprises the steps:
a) read in by said input device one or more standard dimensions for cabinet faces installed for said plurality of residences with said same residence design; and
b) set said real dimensions of said cabinet face equal to one of said standard dimensions for said cabinet faces that is closest to said calculated dimensions of said cabinet face based on said calibrated image dimensions.

12. The kitchen renovation system of claim 1 wherein a number of said plurality of kitchen designs is in the range of 3 to 20.

13. The kitchen renovation system of claim 1 wherein said image of said current kitchen is read in from an archive database of images of said residence.

14. The kitchen renovation system of claim 13 wherein said archive database comprises real estate listing.

15. The kitchen renovation system of claim 1 wherein said measurement-based layout is read in from an archive database of original construction plans for said residence.

16. The kitchen renovation system of claim 1 wherein said measurement-based layout is read in from an archive database of building permits for said residence, said building permits being dated after an original construction date for said residence.

17. The kitchen renovation system of claim 1 wherein said step of presenting to said user by said output device said plurality of said kitchen designs comprises the steps:
a) read in by said input device an image of said current kitchen at a current time; and
b) present by said output device one of said kitchen designs in real time as an augmented reality image showing what said current kitchen would look like with said one of said kitchen designs.

18. The kitchen renovation system of claim 17 wherein said input device and said output device comprise components of a mobile phone and wherein said augmented reality image is presented on a screen of said mobile phone.

19. The kitchen renovation system of claim 1 wherein said image of said current kitchen is a portion of a movie or a three-dimensional image.
